(19) United States
(12) Patent Application Publication
(10) Pub. No.: US 2006/0162502 A1
(43) Pub. Date: Jul. 27, 2006

(54) Tong for loading and unloading

(75) Inventor: Yuan-Yu Huang, Taipei City (TW)

Correspondence Address: TROXELL LAW OFFICE PLLC, SUITE 1404, 5205 LEESBURG PIKE, FALLS CHURCH, VA, 22041, US

(73) Assignee: HANSDER ENGINEERING CO., LTD.

(21) Appl. No.: 11/181,737

(22) Filed: Jul. 15, 2005

(30) Foreign Application Priority Data
Jan. 21, 2005 (TW) 094201170

(51) Int. Cl. H01K 3/32

(52) U.S. Cl. 81/53.12

(57) ABSTRACT

A tong with a shaft is used for loading or unloading a device on high by the clipping sections of the body of the tong.

### FIELD OF THE INVENTION

The present invention relates to a tong; more particularly, relates to load or unload a device on high by a plurality of clipping sections of a body with a shaft.

### DESCRIPTION OF THE RELATED ART(S)

Generally, when a user is loading or unloading a light bulb, a fire locator or a smoke detector, the lightening section at an end of the light bulb is held where a spiral-fixing section at the other end of the light bulb is corresponding to a lamp holder. Then, by turning the light bulb with bare hand, the light bulb is loaded or unloaded on the lamp holder by a spiral-fixing section at an end; or, a fire locator or a smoke detector is loaded or unloaded by turning its body with bare hand.

Although the users usually loading and unloading the light bulb, etc. with their bare hand, the light bulb, the fire locator or the smoke detector is generally set on high, such as a ceiling. Thus, when the user loads or unloads the light bulb, the fire locator or the smoke detector, a ladder or a tall chair is required for the user to stand on to be lifted higher for loading or unloading the light bulb, the fire locator or the smoke detector. Nevertheless, when the user stands on the ladder or the tall chair, the user might fall down because of the fluttering of the ladder or the chair, of the acrophobia of the user, or of not standing firm enough. Besides, when holding the lightening section of the light bulb with bare hand, the hand of the user might be burnt owing to the high temperature at the lightening section, or be in danger of an electric shock owing to the electric leakage of the light bulb. So, the prior art does not fulfill users' requests on actual use.

### SUMMARY OF THE INVENTION

Therefore, the main purpose of the present invention is to load or unload a device on high by a plurality of clipping sections of a body with a shaft.

To achieve the above purpose, the present invention is a tong for loading and unloading, comprising a body and a shaft. The body comprises a containing part, a plurality of split-up slots on the rim of the body, and an elastic member corresponding to the plurality of clipping sections. The containing part comprises an opening at an end. The split-up slots form a plurality of clipping sections. And, the shaft is set at the other end of the body.

### BRIEF DESCRIPTIONS OF THE DRAWINGS

The present invention will be better understood from the following detailed descriptions of the preferred embodiments according to the present invention, taken in conjunction with the accompanying drawings, in which

FIG. 1 is a perspective view of a first preferred embodiment according to the present invention;

FIG. 2 is an exploded view of the first preferred embodiment according to the present invention;

FIG. 3 and FIG. 4 are sectional views of a status of use of the first preferred embodiment according to the present invention;

FIG. 5 is a sectional view of another status of use of the first preferred embodiment according to the present invention;

FIG. 6 is a perspective view of a second preferred embodiment according to the present invention;

FIG. 7 is a perspective view of a third preferred embodiment according to the present invention;

FIG. 8 is a perspective view of a fourth preferred embodiment according to the present invention; and

FIG. 9 is a perspective view of a fifth preferred embodiment according to the present invention.

### DESCRIPTION OF THE PREFERRED EMBODIMENTS

The following descriptions of the preferred embodiments are provided to understand the features and the structures of the present invention.

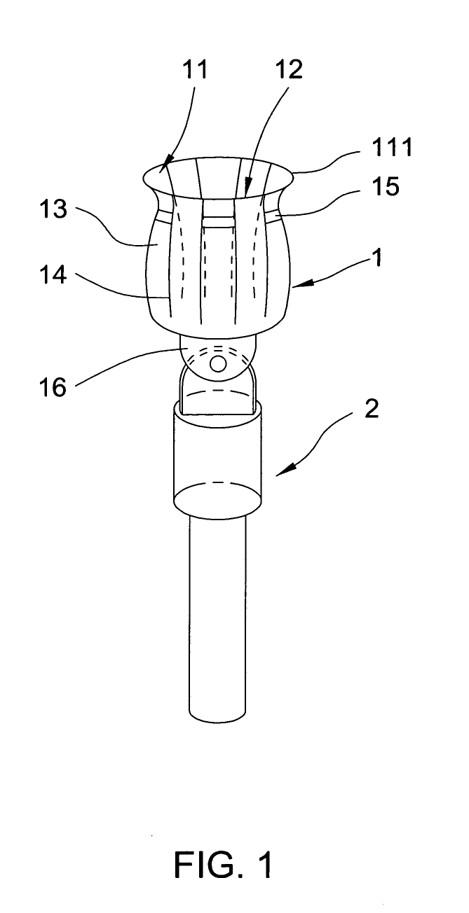

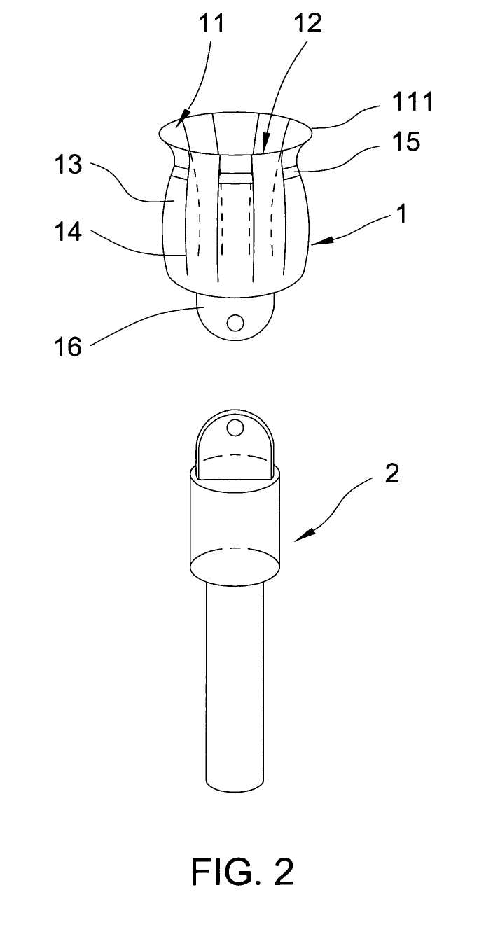

Please refer to FIG. 1 and FIG. 2, which are a perspective view and an exploded view of a first preferred embodiment according to the present invention. As shown the figures, the present invention is a tong for loading and unloading, comprising a body 1 and a shaft 2, where loading or unloading a device on high can be done by a plurality of clipping sections of the body 1 with the help of the shaft 2.

The above-mentioned body 1 is made of PVC (polyvinyl chloride) to be deflectable. The body 1 comprises a containing part 12 with an opening 11 at an end. An expansion section 111 can be set at the opening 11 of the body 1. The body 1 can be a tube with a containing part 12 of a cylinder, where a plurality of split-up slots 13 are on the rim of the body 1 to form a plurality of clipping sections 14; and where an elastic member 15 is set on the body 1 corresponding to the plurality of clipping sections 14. The elastic member 15 can be a plank rubber band interleaved weaved through the plurality of clipping sections 14. And, a connection section 16 is deposed at the other end of the body 1.

The shaft 2 is linked with the connection section 16 at the other end of the body 1; and the shaft 2 can be a flexible shaft. Thus, a novel tong for loading and unloading is constructed by the above structure.

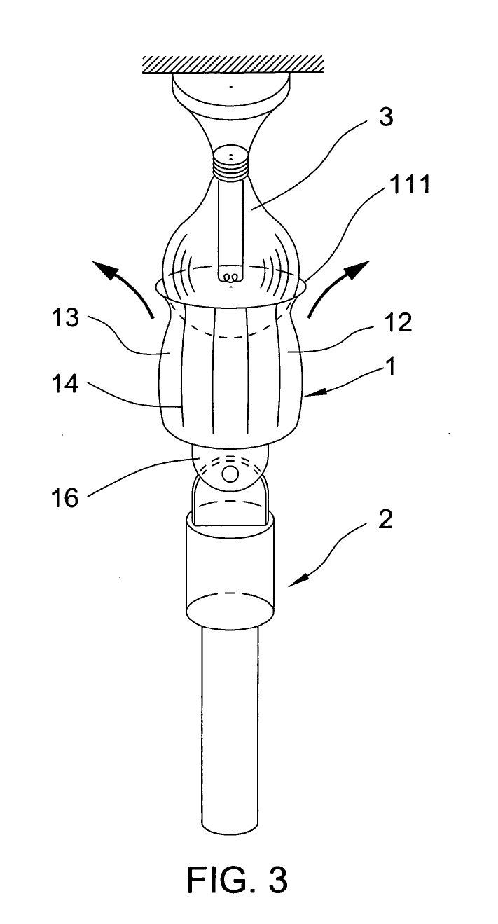

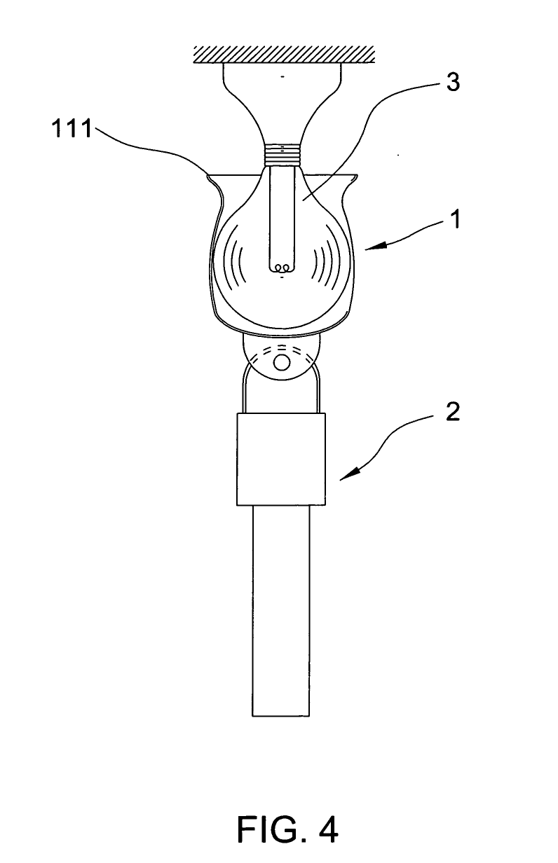

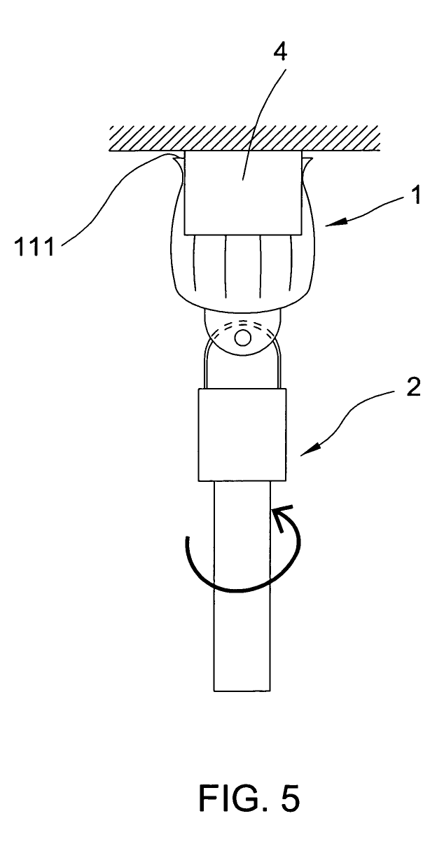

Please refer to FIG. 3 through FIG. 5 which are sectional views of a status of use and a sectional view of another status of use of the first preferred embodiment according to the present invention. As shown in the figures, when loading or unloading a light bulb 3 or a smoke detector 4 with the present invention, the user adjusts the length of the shaft 2 at first. Then, the opening 11 of the body 1 is corresponding to the position of the light bulb 3 or the smoke detector 4. A force is then applied so that, with the coordination of the opening 11, the expansion section 111, and the elastic member 14, the light bulb 3 or the smoke detector 4 can be clipped in the containing part 12 of the body 1. As a result, the clipping sections are clipped at the outside of the light bulb 3 or the smoke detector 4 with the help of the elastic member 15. At this moment, simply by turning the shaft 1, the light bulb 3 or the smoke detector 4 can be loaded or unloaded.

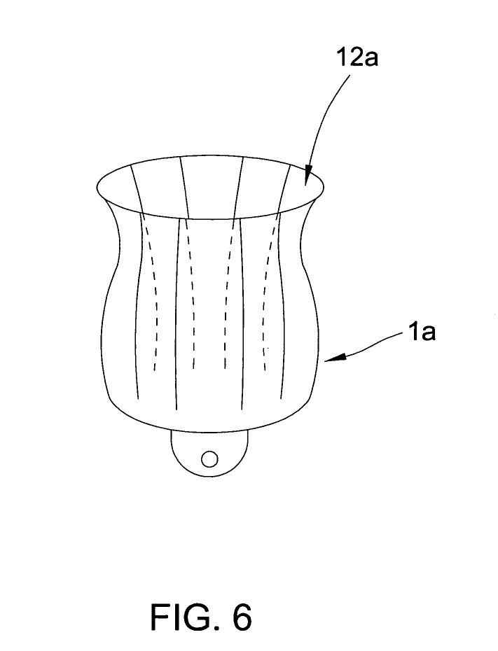

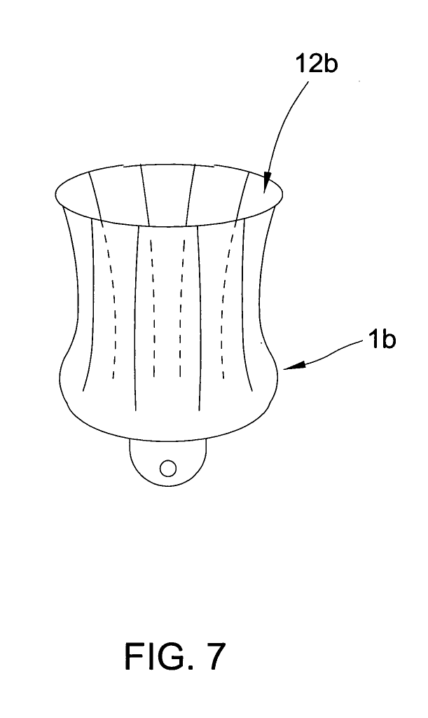

Please refer to FIG. 6 and FIG. 7, which are perspective views of a second and a third preferred embodiments according to the present invention. As sown in the figures, the body 1a of the present invention can be a tube with a containing part 12a of concave surface; or, the body 1b can be a tube with a containing part 12b of convex surface, according to the requirement for an actual usage.

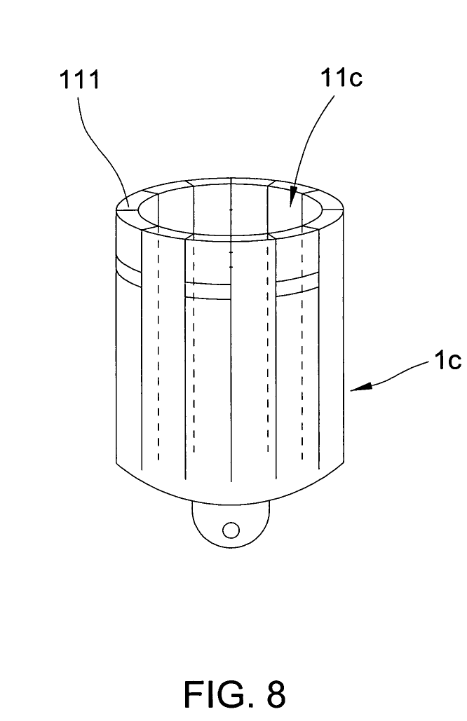

Please refer to FIG. 8, which is a perspective view of a fourth preferred embodiment according to the present invention. As shown in the figure, an expansion section 111 can be set at the opening 11 of the body 1 as shown in the previous figures; in addition, a buffer section 112 can be set at the opening 11c of the body 1c.

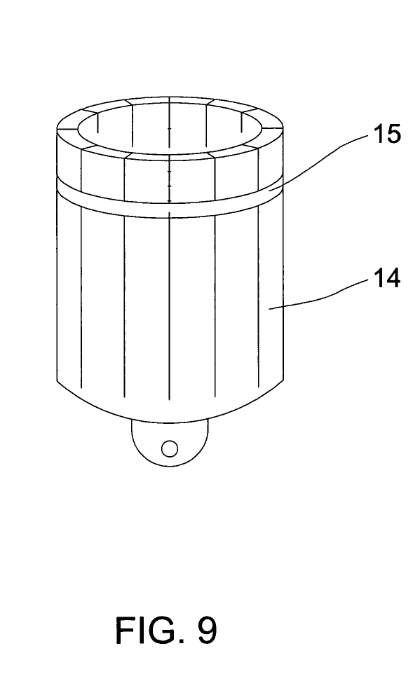

Please refer to FIG. 9, which is a perspective view of a fifth preferred embodiment according to the present invention. As shown in the figure, the elastic member 15 can be interleaved weaved through the plurality of clipping sections; or, in addition, the elastic member 15 can be directly slipped outside of the plurality of clipping sections.

To sum up, the present invention is a tong for loading and unloading by a plurality of clipping sections of a body with a shaft to load or unload a device on high.

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present inventtion.

What is claimed is:

1. A tong for loading and unloading, comprising:
a body, having a containing part with an opening at an end of said body, a plurality of split-up slots at a rim of said opening to form a plurality of clipping sections on said body, and an elastic member on said body corresponding to said plurality of clipping sections; and
a shaft at the other end of said body.

2. The tong for loading and unloading according to claim 1, wherein said body is made of PVC (polyvinyl chloride).

3. The tong for loading and unloading according to claim 1, wherein said body is a tube with a containing part of a cylinder.

4. The tong for loading and unloading according to claim 1, wherein said body is a tube with a containing part having a concave surface.

5. The tong for loading and unloading according to claim 1, wherein said body is a tube with a containing part having a convex surface.

6. The tong for loading and unloading according to claim 1, wherein a buffer section is deposed at said opening of said body.

7. The tong for loading and unloading according to claim 1, wherein an expansion section is deposed at said opening of said body.

8. The tong for loading and unloading according to claim 1, wherein said elastic member is a plank rubber band.

9. The tong for loading and unloading according to claim 1, wherein said elastic member is interleaved weaved through said plurality of clipping sections.

10. The tong for loading and unloading according to claim 1, wherein said elastic member is slipped outside of said plurality of clipping sections.

11. The tong for loading and unloading according to claim 1, wherein said body comprises a connection section connected with said shaft.

12. The tong for loading and unloading according to claim 1, wherein said shaft is a flexible shaft.
